(19) United States
(12) Patent Application Publication
(10) Pub. No.: US 2009/0126479 A1
(43) Pub. Date: May 21, 2009

(54) Depth Indicator for Indicating The Depth of a Settable Material and a Method of Applying a layer of a Settable Material onto a Support Surface

(76) Inventor: Albert John Loncaric, Victoria Point (AU)

Correspondence Address: FISH & RICHARDSON P.C., PO BOX 1022, MINNEAPOLIS, MN, 55440-1022, US

(21) Appl. No.: 11/577,300

(22) PCT Filed: Oct. 13, 2005
(86) PCT No.: PCT/AU2005/001589

§ 371 Date: Sep. 26, 2007

(30) Foreign Application Priority Data
Oct. 13, 2004 (AU) 2004905884
Dec. 20, 2004 (AU) 2004907201

(51) Int. Cl. G01F 23/00

(52) U.S. Cl. 73/290 R

(57) ABSTRACT

An indicator (1) for indicating the depth of a layer of a settable material (45) that has been applied to a support surface (42) is disclosed. The indicator (1) comprises a base (2) defining a contact surface for mounting on the support surface, and a shank (5) having one end mounted on said base (2) and projecting transverse away from the base (2) to a free end remote from said base (2). An indicating marker (20) is positioned on the shank (2) for indicating the depth of settable material when it is filled up to the level of the marker (20). The indicator (1) also includes a cap (30) mounted on the free end of the shank (5). A method of applying a layer of settable material onto a support surface (42) using the indicator (1) is also disclosed. The method comprises the steps of providing at least one depth indicator (1) and placing the indicator (1) on the support surface (42) and adhering it thereto. Thereafter the settable material is applied to the support surface (42). The depth of the material on the support surface is measured from the length of the shank of the indicator that still remains exposed. The material is applied in a thickness that extends up to the indicating marker (20) to provide a layer of material or required thickness.

### FIELD OF THE INVENTION

This invention relates to a depth indicator for indicating the depth of a settable material. This invention also relates to a method of applying a layer of a settable material onto a support surface.

This invention relates particularly to an indicator for indicating the depth of fibrecrete, used for screening a rock wall in a tunnel, and a method for applying a fibrecrete screening to a rock wall in a tunnel, e.g. a tunnel in an underground mine. It will therefore be convenient to hereinafter describe the invention with reference to this example application. However it is to be clearly understood that the invention is capable of broader application.

The invention is particularly applicable where the settable material is applied to an uneven support surface such as where rock has been broken or blasted necessarily leaving an uneven surface. For example the invention could be applied to any application where cementitious material is poured or sprayed onto a rock surface and where it is desirable that operators and engineers can know with reliability the thickness of the layer of material. This could be a civil engineering works where a rock wall has been cut and it is necessary to cover it with a layer of concrete or shotcrete. It could also be used to measure the thickness of a layer of concrete forming the shell of a swimming pool in a backyard. In essence the principles of the invention could be applied to any situation where a layer of settable material is laid down and it is desirable to know the thickness of the layer of settable material.

### BACKGROUND TO THE INVENTION

Underground mining is carried out on a large scale in Australia and indeed many other countries of the world. During the course of underground mining, mine shafts and tunnels are excavated in the rock, and these are used to provide passages to provide access to a mine face. During mining operations, people and mine vehicles, including vehicles for transporting the mine ore, move though these tunnels and passages on a regular basis.

The rock walls lining these passages can crack and degenerate over time. This poses a risk of rocks falling down from a wall or roof of the passage onto the floor below. This clearly poses a risk to the safety of mine workers passing through the passages. Accordingly good mining practice requires these passages to be screened or lined after they have been blasted to resist or discourage rocks from falling down and injuring persons in the passages and also stop them from damaging equipment.

Currently there are two ways of screening these passages. One such way involves placing mesh over the exposed rock of the passage. The mesh forms a barrier having apertures that is intended to stop rocks from falling into the passage. However this method has some shortcomings. The mesh has fairly large openings and a piece of rock could still fall through such an opening. Further the mesh tends to rust and sections then need to be replaced. The replacement of sections on mesh is a hazardous operation in itself. There is always the risk that rocks will fall down from the roof when the original section is removed.

Another recognised method of screening the mine-shaft involves spraying a cementitious material that is fibrecrete onto the exposed rock to line the passage with this material. This method is preferred because fibrecrete is very durable and will last for 10 years or more without deteriorating. Fibrecrete comprises a cementitious material together with steel fibres that strengthen the mix.

However, the difficulty with screening the rock surface with fibrecrete is that it is difficult to know from a visual inspection of the surface the thickness of the layer of fibrecrete, both while it is being laid down and also once the layer has been put down. The fibrecrete is opaque and thus visual inspection of an applied layer gives no indication of the thickness of the material. Further the rock surface is uneven and an edge region of the fibrecrete will not reliably indicate the thickness of the fibrecrete layer.

Currently operators rely on intuition and guesswork to estimate the thickness of the layer they have applied to the rock wall. With these techniques it is very difficult if not impossible for a contractor to apply a uniformly thick layer across the surface of the fibrecrete of the required thickness. As a result a contractor will often end up applying a thicker layer of material to the rock wall than strictly required to provide a safety margin. That way they can say that the layer of material has at least the required thickness with some confidence.

As a result of this approach operator's often use more material and labour than if the fibrecrete was laid down exactly to the prescribed thickness. This increases the costs of doing the job and it is also inefficient.

Currently, the final screen of material or layer of material is checked for meeting the contractual requirements of say 50 mm or 75 mm by drilling into the finished screen at arbitrary points and checking that the depth is 50 mm or 75 mm as the case may be. It will readily be appreciated that this process is very random and does not guarantee that the screen in areas other than those drilled meets the specification.

Clearly therefore it would be advantageous if a technique could be devised for enabling operators, engineers and mine managers to be able to determine the thickness of the fibrecrete also obviated the need to drill into the finished layer to check its thickness. It would also enable mine managers and engineers to check the thickness of the fibrecrete layer in a simple yet effective manner across the full surface of the layer and be confident that the measured thickness was presentative of the actual thickness across the full surface of the screened area.

Such a technique would enable the mining industry as a whole and the government regulators to provide a regulatory framework for checking the thickness of fibrecrete that would help ensure a safe underground mining environment.

It would also be advantageous if a way could be devised of indicating the thickness of the layer of fibrecrete in real time as it was sprayed onto the rock wall. Specifically it would be useful if this could indicate the build up in thickness of the layer to the operators while they were spraying the layer of fibrecrete onto the rock wall. It would be particularly useful if this did not require operators to stop spraying and then use another instrument to measure the thickness.

Applicant believes that such a contrivance and technique would represent a major breakthrough in this industry and would represent a win-win situation for all stakeholders.

### SUMMARY OF THE INVENTION

According to one aspect of this invention there is provided an indicator for indicating the depth of a layer of a settable material that has been applied, eg poured or sprayed, onto a support surface, the indicator comprising:
a base defining a contact surface for mounting on a support surface; and
a shank having one end mounted on said base and projecting transverse away from the base to a free end remote from said base.

The depth of settable material can be determined from the height of the settable material on the shank.

The base and the shank together may have a length or height that is at least that of the thickness of the settable material that is to be laid on the support surface.

The indicator may include at least one indicating marker on the shank for indicating a depth of settable material on the support surface when it is filled up to the level of the indicating marker. The indicating marker on the shank may indicate a depth of 50 mm, 75 mm or 100 mm.

The settable material may be a flowable non transparent material, e.g. a slurry of opaque material, such that its depth cannot be ascertained or estimated from a visual inspection of the material. In a major application of the invention as envisaged by the Applicant the indicator will be used to indicate the depth of a flowable settable material that is a cementitious material such as a concrete slurry, e.g. fibrecrete or shotcrete, that is used to line or screen the walls and ceilings of tunnels and the like. Often these tunnels will be in underground mines.

In use the base is adhered to the support surface with the shank projecting outward away there from transverse to the support surface. The material is then sprayed onto the support surface and the depth of the settable material can be obtained by observing the exposed length of the shank. For example, if a 25 mm length of the shank is exposed and the indicator is 50 mm long, then the layer of material is 25 mm deep or thick. This provides a reliable indication of the depth of the settable material. The length of the indicator is the length of the shank plus the height or thickness of the base. The base is usually quite thin relative to the length of the shank.

The base may be flattened and have two major surfaces namely said contact surface for mounting on the support surface and also an opposed or outward surface for facing away from the support surface on which the indicator is mounted.

The base may be sized to be larger than that of nozzles that are typically used to spray fibrecrete onto the tunnel walls. The base may be circular in which case the diameter of the base will be larger than that of the nozzle. That way the indicator can be mounted over the open end of an upwardly facing nozzle and be supported by the nozzle. The upwardly pointed nozzle with the indicator supported on its end can then be used to place the indicator on the support surface, eg the roof of the passage.

The base may include a locating formation on said outward surface for correctly locating the base on a said nozzle, eg in the correct position, before it is placed in position on the support surface. The locating formation may be in the form of a shoulder, eg of circular shape, spaced radially in from the peripheral edge of the base. The shoulder spaced radially inward of the peripheral edge may be sized to fit just inside the typical nozzle with a small amount of clearance. This serves to locate the base centrally and in position on the nozzle.

Thus the peripheral edge of the base may be sufficiently large that it can be placed on top of a said nozzle of the type usually used in the industry and extend radially outwardly beyond the edge of a wall of the nozzle so that the wall of the nozzle will support it on the end of the nozzle.

The contact surface of the base may define a recess, eg a shallow recess, slightly inward of the peripheral edge. The recess permits adhesive to remain between the contact surface and the support surface when the base is pressed against the support surface. The recess may be formed by a peripheral skirt projecting down below the rest of the contact surface.

The base may be adhered to the support surface using adhesive that is applied to the contact surface of the base before it is placed on the nozzle. That way the indicator is adhered to the support surface and remains in place when the settable material is subsequently sprayed onto the surface.

The base may further define one or more apertures passing there through from the contact surface to the outward surface. Preferably, there are a plurality of said apertures spaced apart from each other across the outward surface. The apertures permit the adhesive that is applied to the contact surface to ooze through the apertures when the base is pressed against the support surface.

Each aperture should have a sufficiently large diameter to permit a reasonably viscous adhesive to pass therethrough when pressure is applied thereto. The diameter of each aperture may be 2-6 mm, preferably 3-5 mm, eg about 4 mm. In a preferred form there are 5 to 7 apertures although it is quite clear that this number could vary.

The shank may comprise a main shank portion and a free end portion of smaller cross-sectional area than the main shank portion.

The main shank portion may have a noncircular cross-sectional configuration. The main shank portion may have a cross-sectional configuration in the shape of a figure having a plurality of sides, eg a plurality of linear sides. In a preferred form the main shank portion has a cross sectional shape in the form of a cross or a cruciform.

The sides of the shank provide a surface against which the settable material can bear when it is sprayed out of the nozzle and this helps to guide the settable material along the shank and up against the outer surface of the base.

This in turn helps to direct the material issuing from the nozzle onto the base to pack the indicator against the support surface and resist it being dislodged. If the main shank portion had a circular configuration of small radius the settable material would travel past the shank and would not be directed up against the base. This would make it vulnerable to being dislodged during the initial stages of application of the material.

The free end portion may be of substantially smaller cross-sectional area than the main shank portion and may be of circular or rectangular, e.g. square rectangular cross-sectional area. The free end portion may have a length less than that of the main shank portion, e.g. less than half that of the main shank portion. The free end portion may form an attachment formation, e.g. a male formation such as a spigot, for mounting another component on the shank of the indicator.

The indicating marker for indicating the depth of the settable material may be formed by the end of the main shank portion of the shank or it may be formed by the end of the free end portion of the shank. In one form the marker is formed by the end of the main shank portion of the shank. Thus if the settable material is filled up to this point then the settable material has the indicated thickness. For example, if the thickness of the material is required to be 50 mm and the end of the main shank portion is 50 mm away from the contact surface of the base, it will indicate a depth of 50 mm when the layer of settable material has been built up to the marker.

Obviously it is not necessary for the indicator to have a length of 50 mm to indicate a depth of material of 50 mm. It could have a length of more than 50 mm and an indicating marker showing 50 mm along the length of the shank. This way an indicator longer than 50 mm could still indicate a depth of 50 mm.

Further the marker need not be on the shank. The marker could also be on a component mounted on the shank such as a cap.

Yet further the shank could also indicate the depth from the base to the free end in small increments, eg of 1 mm each or 1 cm each much like a ruler.

The indicator may include a cap removably mounted on the free end portion of the shank. Further the cap may include a passage within which the free end of the shank portion is received, e.g. snugly, to releasably mount the cap on the shank.

The cap may have a cross-sectional area greater than that of the shank. The cap may include a cap body and a disc, e.g. separate from the cap body, and the disc may be sandwiched between the cap body and the shank. The cap body and the disc may each define a centrally positioned said passage within which the free end portion is received.

The cap body may have a conical part towards its free end and a cylindrical part behind the conical part and remote from its free end.

The cap, e.g. the disc of the cap, may have a surface that abuts the end of the main shank portion so that it is adjacent the marker of the thickness of the settable material.

Thus when the settable material has been laid down to the point where it extends up to the cap it will have at least the depth indicated by the marker formed by the end of the main shank portion. At this stage the only part of the indicator that will be visible on the surface of the fibrecrete will be the cap or at least part of it.

Any subsequent blasting of the tunnel in a downstream region of the tunnel, may have the effect of blasting off the main body portion of the cap. If that occurs the disc will still remain on the shank and provide a large coloured disc that can be easily seen by operators standing about 5 m away. Thus the cap and disc serves the function of pointing out the position of the indicators in the tunnel.

The indicating marker indicating the depth of the material may be capable of indicating more than one depth. For example, it may indicate a first depth of 50 mm and then a second depth of 75 mm.

Conveniently, this might be accomplished by the indicator having a 50 mm length and then a shank extension of 25 mm that is mounted on the free end portion of the shank to give it a length of 75 mm. Conveniently the extension may be made of a different colour to that of the shank, the different colour being a standard for say indicating 75 mm.

The depth indicator may have a further shank extension of say another 25 mm so that when this is mounted on said one extension the shank together with said one and further extensions has a length of 100 mm.

The shank and the extensions may define complementary mounting formations for enabling the first extension to be mounted on the free end portion of the shank and then the further extension on said first extension.

Conveniently the first extension may define a passage within which the free end portion of the shank is received. Similarly the further extension may define a passage within which a leading end of the first extension is received whereby to hold the further extension releasably on the first extension and thereby also the indicator.

The indicating marker on the indicator with at least one extension may be formed by the leading end of the leading or outermost extension. For example if the indicator has one extension the leading end of this extension. If the indicator has two extensions the indicating marker will be formed by the leading end of the further or second extension.

The base and shank may be integrally moulded from plastics material, eg polyethylene, in a single moulding operation. The cap including disc and main body portion and also the extensions may also each be moulded from plastics material by injection moulding.

The indicator may further include means for visually indicating when a predetermined time has elapsed, mounted on the shank. The purpose of the visual indicator of elapsed time is that it indicates when sufficient time has elapsed since the fibrecrete was sprayed onto the rock walls for the early strength of the fibrecrete to be sufficient to allow workers back into that area of the tunnel.

The means for visually indicating elapsed time may indicate when the means have been activated, e.g. by an operator, and may also indicate when the predetermined time has elapsed. Thus the indicating means visually show when the predetermined time has elapsed.

The visual indicating means may be positioned on the shank, beyond the indicating marker and the designated thickness of the layer of material, such that it projects out above the material layer once the material has been applied to the surface to required thickness.

The visual indicating means may indicate when the predetermined time has elapsed by changing its visual appearance. Specifically the indicating means may illuminate or glow when activated, eg when fibrecrete is sprayed onto the surface. The indicating means may then stop glowing or illuminating once the predetermined time has elapsed.

Conveniently the visual indicating means of the indicator may be activated just prior to it being placed on the end of a nozzle and mounted to the support surface. This is done just before the fibrecrete is sprayed onto the support surface. As the fibrecrete is applied to the support surface shortly after the indicators are mounted on the support surface this is broadly timed to coincide with the application of the fibrecrete to the support surface. It is thus a practical way of indicating approximately how much time has elapsed, since the fibrecrete was laid onto the support surface, e.g. rock wall. This therefore incorporates the operation of the visual indicator of elapsed time into the working process of using the depth indicators to indicate the depth of fibrecrete in a practical and easy to use way.

The predetermined time that is measured by the elapsed time indicating means may be any time from one to three hours, e.g. one hour or two hours. The predetermined time is the time that is required to elapse before personnel can be permitted to re-enter the area to which the fibrecrete has been applied. Generally this will be specified by the engineers in charge of the site based on local conditions such as the rock type and its strength and experience with this rock.

The visual indicating means may comprise two containers, each containing a different material, that when mixed together catalyse a reaction that causes the material to glow. The containers may comprise having an inner container made of a brittle material that can be cracked open by bending of the container and an outer container that is less brittle within which the inner container is received. The two containers contain different liquid components that mix when the inner container is cracked thereby catalysing the reaction that causes the liquid to glow.

The two containers of the indicating means may form part of the shank of the indicator. The two containers may form the free end portion of the shank. Instead the two containers may form the main shank portion of the shank. Further instead the two containers may form a said cap mounted on the shank.

The indicator for indicating the depth of a layer of a settable material may further include a support formation that is suitable for supporting one or more articles there from that is mounted on the shank towards the free end thereof. The support formation may be in the form of a loop or a hook formation for supporting cables and conduits therefrom.

Thus some indicators mounted on the roof of the tunnel may have support formations to permit them to carry pipes, cables or the like.

The support formation may extend out from the free end of the shank beyond the marker of the depth of the settable material within which it is received.

In one form the support formation may be integral with the shank.

In another form the support formation may be attached to the shank. The indicator may include attachment formations on the shank towards its free end, for attaching the support formation thereto, e.g. releasably. Further the support formation may include complementary attachment formations for engaging the attachment formations on the shank thereby to support it or hang it from the shank.

The attachment formations on the shank may comprise an external screw thread on the shank towards the free end thereof and the complementary attachment means on the support formation may comprise a bore defining an internal screw thread within which the screw thread on the shank is receivably engaged.

According to yet another aspect of this invention there is provided a support for mounting to a support surface, to which a settable material is to be applied, the support comprising:
a base defining a contact surface for mounting on a support surface;
a shank having one end mounted on said base and projecting transverse away from the base to a free end remote from said base; and
a formation that is suitable for supporting articles therefrom or attaching articles there to that is mounted on the shank towards the free end thereof.

The base and the shank may have a length that is at least that of the settable material that is to be laid on the support surface. For example the support formation may extend out from the free end of the shank beyond a marker of the depth of the settable material within which it is to be received.

The formation may be a support formation in the form of a hook or a loop that is suitable for hanging articles such as cables, pipes or the like, there from.

The support formation may be integral with the shank.

Instead the support formation may be attached to the shank. The indicator may include attachment formations on the shank towards the free end of the shank for, e.g. releasably, attaching it to the support formation. Further the support formation may include complementary attachment formations for engaging the attachment formations on the shank thereby to support it or hang it from the shank.

The attachment formations on the shank may comprise an external screw thread on the shank towards the free end thereof and the complementary attachment means on the hanging formation may comprise a bore defining an internal screw thread within which the screw thread on the shank is received.

According to another aspect of this invention there is provided a method of applying a settable material onto a support surface, method comprising the steps of:
providing at least one depth indicator as described above according to the first aspect of the invention;
placing the indicator on said support surface and adhering it thereto; and
applying the settable material to the support surface;
whereby to indicate the depth of the material on the support surface by the length of the shank of the indicator that still remains exposed and is not covered by the settable material

The indicator may include any one or more of the optional features of the indicator described in the first aspect of the invention above.

Specifically the indicator may include an indicating marker on the shank for indicating the depth of the settable material and the step of applying the settable material may include applying a layer of material at least up to the level of the indicating marker.

The step of observing the depth of the material may comprise taking the known length of the indicator, i.e. the length of the shank and height of the base, and subtracting from it the exposed length of shank to arrive at the depth of material that has been put down on the support surface.

The settable material may be cementitious material, eg concrete, cement or fibrecrete and the material may be in the form of slurry that is pumped or sprayed onto the support surface with a nozzle.

The support surface may be a rock surface, eg a rock wall in an underground passage or tunnel, and the material that is placed on the wall may be fibrecrete.

The method may include the initial step of placing the indicator over the end of a nozzle of a slurry pumping apparatus prior to the step of placing it on the support surface. This way the nozzle can be used to provide increased reach to place the indicator at the appropriate position on the support surface.

The method may also include the initial step of placing adhesive on the contact surface of the base of the indicator. The adhesive may be placed on the base while it is being supported on the end of the nozzle. Thereafter the step of placing and adhering the indicator is carried out.

The step of placing and adhering the indicator on the support surface may include pressing the indicator onto the support surface with pressure such that the adhesive is brought firmly into contact with the support surface and is forced through the apertures in the base member.

The method may include using a boom, e.g. a robotic boom to move the nozzle around and thereby place each indicator on the support surface.

The robotic boom may be mounted on a vehicle that is parked and stabilised by hydraulic legs in proximity to the support surface to which the indicators are to be mounted. The boom may be capable of extension and retraction and also raising and lowering. The boom may also be capable of being rotated through at least 180 degrees on the vehicle.

The method may include placing a plurality of said indicators in position on the support surface at spaced apart positions on the support surface prior to pumping said slurry of settable material onto the wall. The plurality of indicators may be positioned in a pattern, eg an array, on the support surface.

The method may include the further step of providing a visual indicator of elapsed time on at least one depth indicator.

### DETAILED DESCRIPTION OF THE INVENTION

A depth indicator and a method for indicating the depth of a settable material that is fibrecrete on a rock wall in accordance with this invention may manifest itself in a variety of forms. It will be convenient to hereinafter provide a detailed description of several embodiments of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

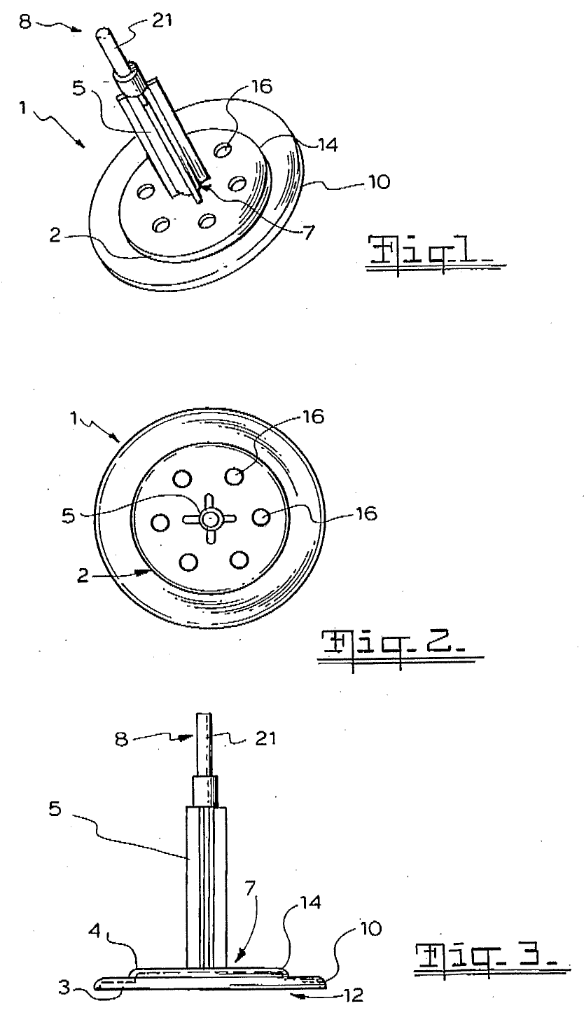

FIG. 1 is a three dimensional view of a depth indicator in accordance with one embodiment of the invention;

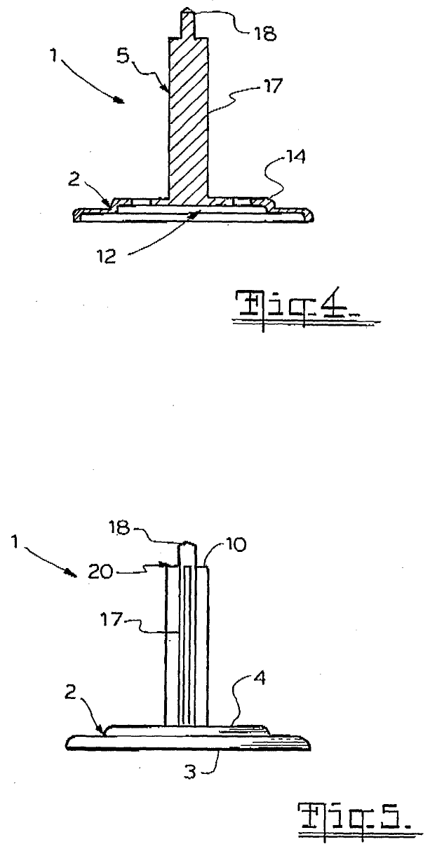

FIG. 2 is a top plan view of the depth indicator of FIG. 1;

FIG. 3 is a front view of the depth indicator of FIG. 1;

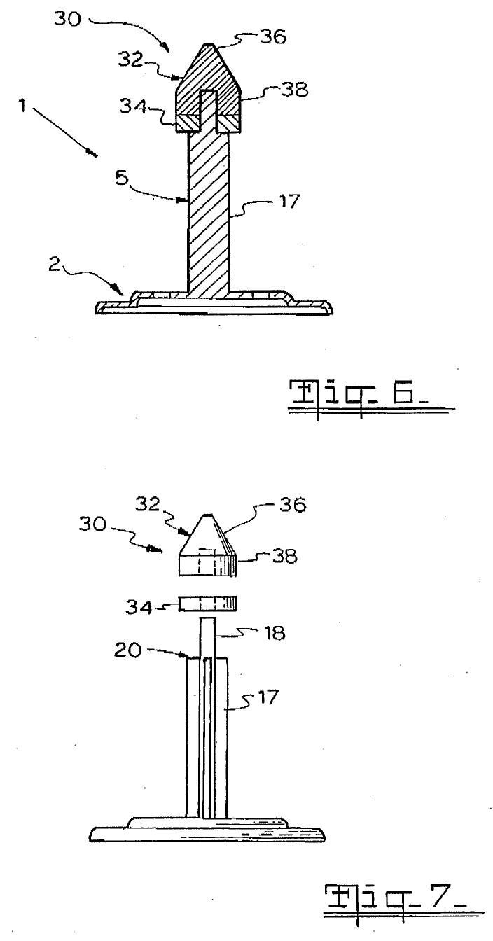

FIG. 4 is a sectional view through the indicator of FIG. 1, less the extension;

FIG. 5 is an exploded front view of the indicator of FIG. 4;

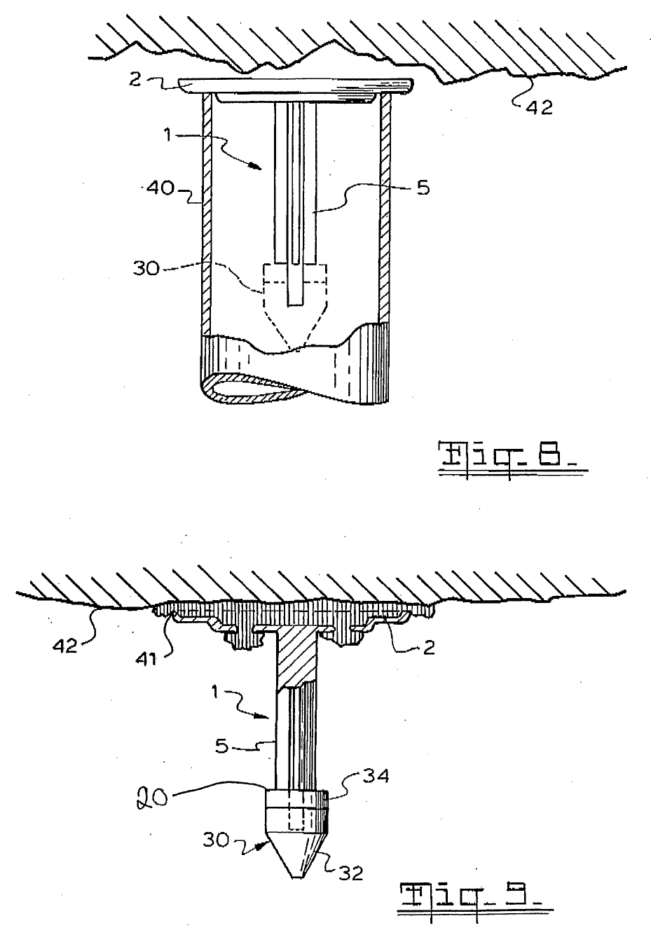

FIG. 6 is a cross-sectional view of the indicator of FIG. 4 fitted with a cap instead of a shank extension;

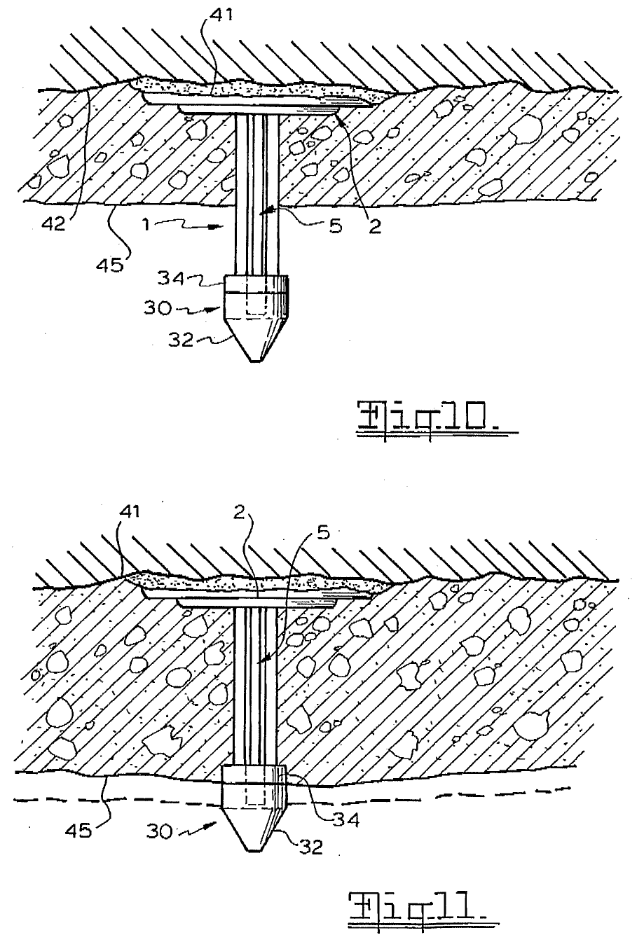

FIG. 7 is an exploded front view of the indicator of FIG. 6.

FIG. 8 is a front view of the indicator of FIG. 6 mounted on a nozzle prior to being placed on a support surface that is a rock wall;

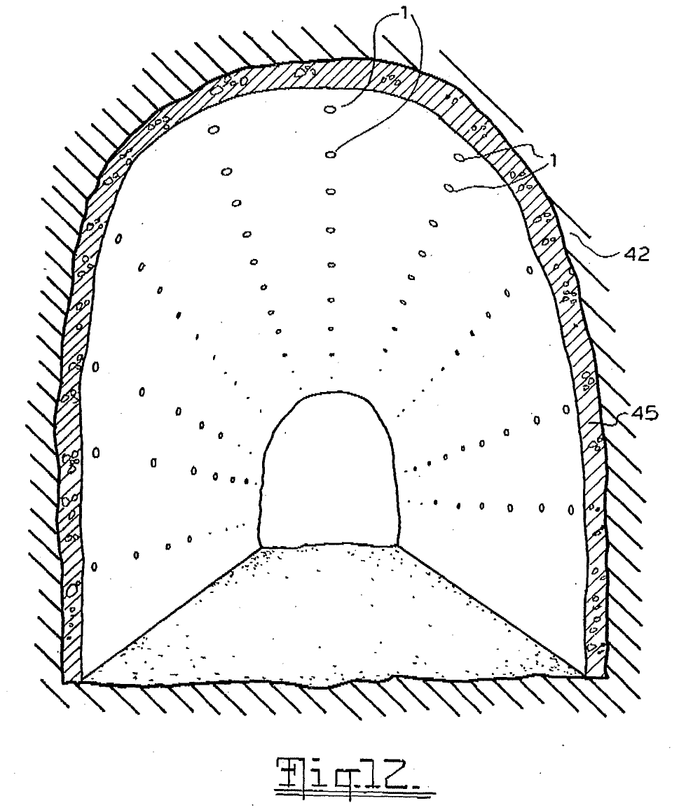

FIG. 9 is a front part sectional view of the indicator of FIG. 6 after it has been adhered to the rock wall and prior to fibrecrete being sprayed onto the wall;

FIG. 10 is a sectional front view of the indicator of FIG. 6 mounted on the wall while the fibrecrete spray is in progress and showing a layer of about 25 mm on the rock wall;

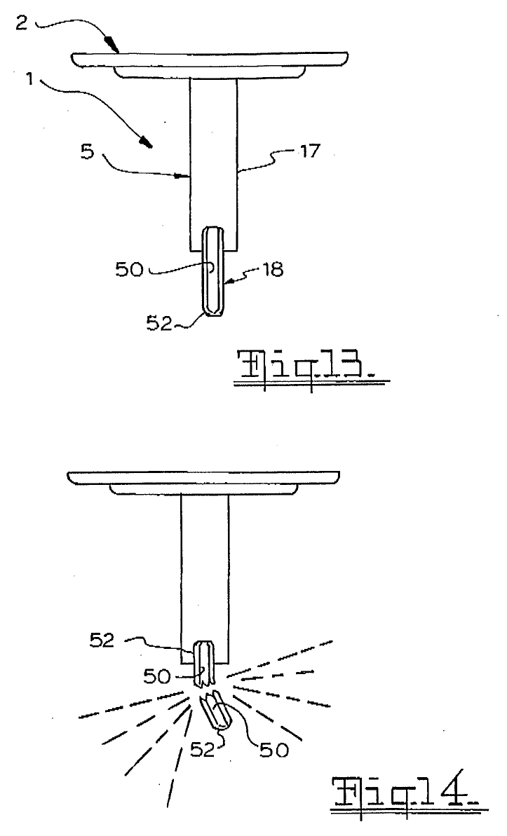

FIG. 11 is a sectional front view of the indicator of FIG. 6 on the wall after the spray has been completed and there is a screen of about 50 mm over the rock wall;

FIG. 12 is a three dimensional view of a tunnel showing an example arrangement of the depth indicators shown in FIG. 6 spaced apart from each other across the surface of the wall;

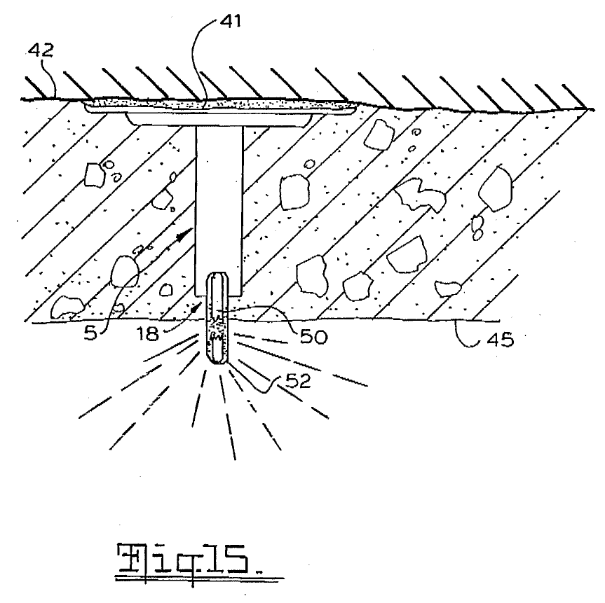

FIG. 13 is a schematic front view of a depth indicator in accordance with a further embodiment of the invention prior to use; and

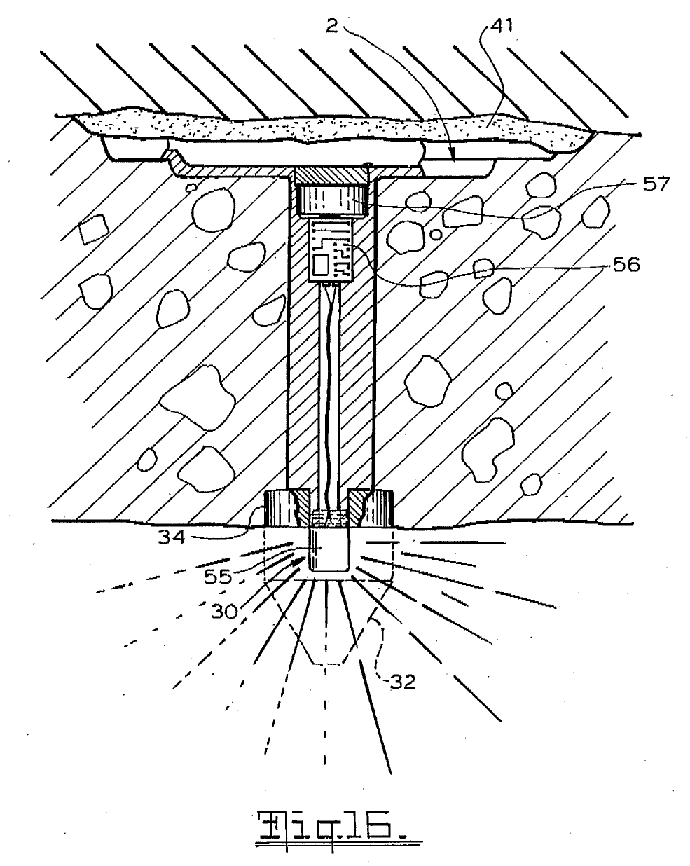

FIG. 14 is a schematic front view of the depth indicator of FIG. 11 after it has been cracked so as to initiate glowing thereof;

FIG. 15 is a sectional view of the indicator of FIG. 14 after it has been mounted on track wall and after the layer of cementitious material has been laid down;

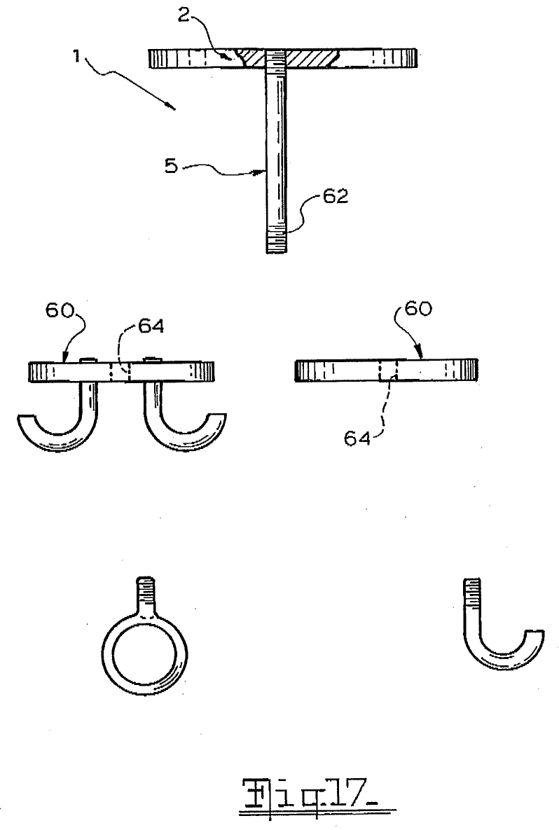

FIG. 16 is a sectional front view of an indicator that is a variation on the indicator of FIGS. 11 to 13;

FIG. 17 is an exploded front view of an indicator in accordance with another embodiment of the invention showing various support formations that may be attached thereto;

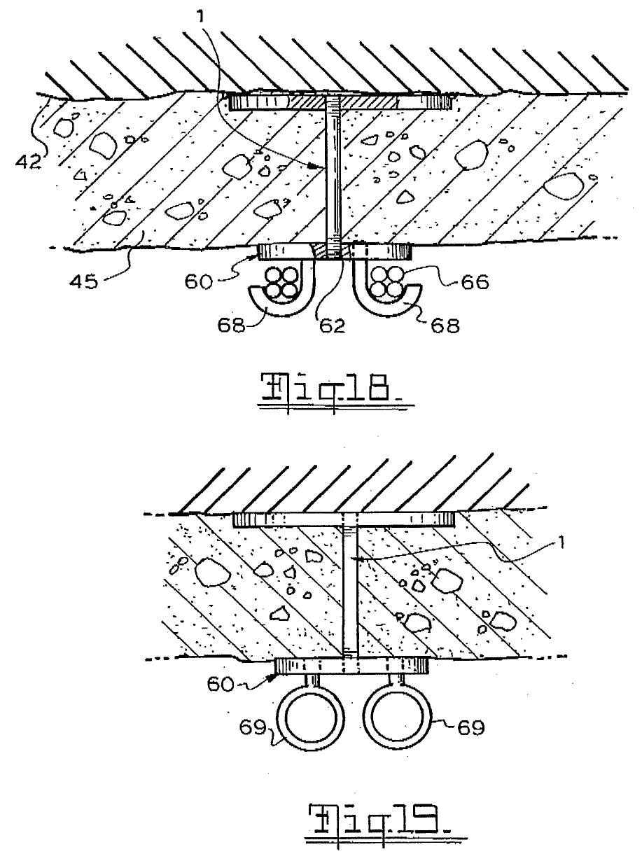

FIG. 18 is a front view of the indicator of FIG. 17 with one said support formation mounted thereto in use supporting a plurality of cables in a passage; and

FIG. 19 is a variation on the indicator in FIG. 18 mounted on a support surface.

In FIGS. 1 to 5 reference numeral 1 refers to a depth indicator in accordance with the invention.

The indicator 1 comprises broadly a base 2 having a contact surface 3 and an outer surface 4. The indicator 1 also includes a shank 5 having one end 7 joining the base 2 and an opposed and free end 8 that is remote from the base 2. The shank 5 projects outwardly away from the base 2 perpendicular to the contact surface 3 and the outer surface 4.

Turning now to describe the base 2 in more detail, the base 2 has a generally circular shape when viewed in plan view. The circumference of the base 2 is sized such that it is larger than most nozzles used for pumping fibrecrete onto surfaces in the mines and construction industries. Generally the diameter of the base 2 will be at least 50 mm. In the illustrated embodiment the base has a diameter of 62 to 64 mm. The base 2 also has a skirt 10 extending downwardly around its periphery. This enables the contact surface 3 to define a recess or cavity 12 between it and the support surface when it is mounted on a support surface. This provides a space for receiving adhesive as will be described in more detail below.

The base 2 also includes a locating formation in the form of a circular ridge 14 on the outer surface 4 spaced radially in from the peripheral edge. The ridge 14 is raised above the surface of the outer surface 4. The ridge 14 serves to locate the base 2 in position when it is placed over the open end of a nozzle just prior to use. The ridge 14 is sized to be received within the open end of the typical nozzle with just a small amount of clearance. This holds it in a stationary position on the nozzle in a position from where it is unlikely to slide off the nozzle.

In the illustrated embodiment the ridge 14 on the outer surface 4 is complemented by a corresponding further recess in the contact surface 3 at the same radial position. However this need not be the case.

In addition the base 2 has a plurality of apertures 16 defined therethrough for allowing adhesive to pass from the contact surface 3 onto the outer surface 4. Each aperture 16 has a diameter of about 3 to 5 mm. It is important that the apertures 16 be large enough to permit viscous adhesive to pass there through without too much resistance. However apart from this there is scope for some variation in the size of the apertures 16.

In the illustrated embodiment the base 2 has six apertures 16 spaced equidistantly apart from each around the base 2 radially inward of the ridge 14.

The shank 5 comprises a main shank portion 17 having a cruciform cross-section and a free end portion 18 mounted on the end of the main shank portion 17. The free end portion 18 has a greatly reduced cross-sectional area when compared to the main shank portion 17.

The surfaces of the cruciform cross-section guide and direct fibrecrete that is pumped out of the nozzle of a concrete spraying apparatus along the shank 5 towards the end 7 at the base 2. This tends to direct the fibrecrete over the outer surface 4 of the base 2 and hold it in position so that it is not dislodged during the application of the fibrecrete.

The free end portion 18 of the shank 5 has a circular cross-sectional area and forms a male formation that is a spigot like protrusion that is used to releasably attach other components thereto as will be described in more detail below.

The shank 5 has an indicating marker 20 for indicating the depth of material required to be laid down. In FIGS. 4 and 5 the indicating marker 20 is formed by the end of the main shank portion 17. This end is 50 mm away from the contact surface on the base 2 of the indicator 1. Thus when the settable material is sprayed onto the support surface up to the marker 20 it will have a depth of 50 mm.

When the support surface is covered with some settable material but the material does not extend up to the marker the thickness of material can easily be calculated by measuring the distance from the surface of the settable material to the marker 20. This distance is subtracted from the depth of material indicated by the marker 20 to give the thickness of the settable material at that time. In the illustrated embodiment the marker 20 indicates a 50 mm depth. The thickness will be obtained by subtracting the exposed length from 50 mm to give the thickness of the material in mm.

The length of the indicator 1 is the thickness of the base 2 plus the total length of the shank 5. Generally the thickness of the base 2 is small when compared with the length of the shank 5.

In FIGS. 1 to 3 the indicator 1 also has a shank extension 21 that is mounted over the free end 8 of the shank 5. The shank 5 and extension 21 can be releasably engaged by complementary male and female formations as shown. The male formation may be formed by the free end portion 18 of the shank 5 described above which is like a spigot. The female formation may be a passage, e.g. a socket that is complementary to this free end portion and is formed in the rear or trailing end of the extension 21.

The extension 21 is used to lengthen the length of the shank 5 if required to indicate a greater depth of material. For example, if the fibrecrete has to be laid down to a 75 mm depth then the extension 21 is mounted on the shank 5 of an indicator with a an indicating marker 20 of 50 mm. A 75 mm indicating marker 20 is then formed by the free end of the extension 21. The base 2 and shank 5 with extension 21 then has a total length of 75 mm and the fibrecrete will have this depth when it extends up to the free end of the extension 21.

In the illustrated embodiment the base 2 and shank 5 is indicated in the colour red and the extension is yellow. These colours then indicate respectively 50 mm and 75 mm. Applicant envisages using the colours in this way to develop a universally understood standard in relation to the use of the indicator. For example if a further extension is mounted on the first extension it may have a different colour again, say white.

In FIGS. 6 and 7 a cap is fitted over the free end portion of the shank of the indicator in FIG. 1 (without the extension).

The cap 30 comprises a cap body 32 and a separate disc 34 beneath the cap body 32. The cap body 32 has a cone shaped part 36 at its outer end and a cylindrical part 38 behind the cone shaped part 36. The cap 30 is characterised by the fact that it has a greater cross-sectional area than the shank 5 of the indicator 1.

The cap body 32 and the disc 34 each define a central passage within which the free end portion 18 of the shank 5 is received, e.g. snugly. This holds the cap 30 releasably mounted in position on the shank 5 of the indicator 1.

As described above the end of the main shank portion 17 forms the indicating marker 21 that indicates say a depth of 50 mm. Thus the cap 30 sits on the shank with the disc thereof adjacent the end of the main shank portion 17. Thus when the settable material is laid down provided that it extends up and around the cap 30 it will have achieved the depth indicated by the indicating marker.

The cylindrical part 38 of the cap body 32 may have a length of about 10 mm. Thus provided the settable material does not fully cover the cylindrical body part 38 of the cap 30 it will not have been applied with too great a thickness. It will have met the specification and also laid down a modest or acceptable amount of additional material. If however the material covers the cylindrical body part 38 and also part of the cone part 36 it will have been applied too thickly. These subsidiary markers can be used by both operators and project managers.

The cap 30 can sometimes get detached from the shank 5. This can occur when further blasting takes place in the tunnel, e.g. down the tunnel from the rock wall carrying the indicators 1. The force of the blast can blow the cap body 52 off the shank 5. However the disc 34 of the cap 30 invariably remains on the shank 5 and this provides a large clearly visible surface of distinctive colour that can be visually spotted by users in the tunnel.

The shank 5 and base 2 less the extension 21 may be formed as a single integral article, eg by injection moulding. The extension 18 may also be injection moulded in a separate injection moulding step, as may the cap body 32 and the disc 34. Typically the shank 5 and base 2 is injection moulded from a plastics material such as polyethylene. Further, the plastic may be coloured using techniques that are well known in the art.

In use the first step is to place an indicator 1 in position on a wall 42. This is done by placing the indicator 1 over the open end of the nozzle 40 (of a concrete spraying apparatus).

The outer surface 4 of the base 2 rests on the wall defining the nozzle 40. The ridge 14 on the outer surface 4 projects into the nozzle 40 a small amount and this helps to locate the indicator 1 on the nozzle 40, for example, to centralise the indicator 1. This is shown in FIG. 8.

An adhesive 41 is placed on the contact surface 3 of the indicator 1 for adhering it to the wall 42. The adhesive 41 is received in the shallow recess 12 defined by the skirt 10 and also the further shallow recess aligned with the ridge 14 on the outer surface 4. The nozzle is then used to lift the indicator up into its position on a wall 42. When the indicator 1 is pressed up against the wall 42 the adhesive sticks and holds it in position of the wall 42.

The nozzle 40 is mounted on a robotic boom which in turn is mounted on a vehicle (not shown). The vehicle is stabilised in position near the wall 42 to be covered with material that is fibrecrete and is laterally stabilised by means of the hydraulic arms. The boom is capable of extension and retraction. It is also capable of being raised and lowered. It is also capable of being rotated on the vehicle through 360 degrees. The boom is robotically worked by an operator operating robotic controls on the vehicle.

An operator places the indicator 1 at a suitable point on the wall 42. The nozzle 20 is then detached from the indicator 1 by simply pulling it back away from the wall 42 leaving the indicator 1 on the wall 42. The apertures 16 defined in the base 2 permit adhesive 41 to ooze through the base 2 and onto the outer surface 4 when the indicator 1 is pressed onto the wall 42. This is shown in FIG. 9.

Conveniently polyurethane adhesive may be used. This adhesive is reasonably inexpensive and has been found to adhere the indicator to the rock wall. Alternatively a rapid set adhesive can also be used and this may give even better results although it is more expensive. A rapid set adhesive is usually supplied as two parts that are mixed together just prior to use and this initiates or catalyses the rapid set.

The nozzle 40 is used to place the indicator 1 on the wall 42 because of the additional reach it provides. Very often the roof of a passage is required to be lined and this may be 3 to 5 metres above the floor of the passage. However it is to be appreciated that the indicator 1 could also be manually placed on the wall.

Shortly thereafter the operator commences spraying the wall 42 with fibrecrete to screen the wall 42. The fibrecrete issues from the nozzle 40 as a slurry under pressure and adheres to the wall 42. A layer of fibrecrete is then built up over the wall 42 as the fibrecrete is laid down.

As the layer of fibrecrete 45 is built up over time the shank 5 of the indicator 1 is progressively covered by the fibrecrete starting at the base end and then working up to the end of the main flange portion 17. FIG. 10 shows a layer 45 of 25 mm of fibrecrete laid down on the wall 42. About half the length of the shank 5 is exposed.

With the application of more fibrecrete a point will be reached where the layer 45 extends just past the indicating marker 20 which is formed by the end of the main shank portion 17 as shown in FIG. 11. This is also aligned with the cap 30 which is mounted on the shank 5.

This indicates that a layer 45 of 50 mm of fibrecrete has been applied to the wall 42. Often the screening contracts specify a thickness of screen of 50 mm. If this is the case then the contract specification will have been met and the operator can stop spraying concrete onto the wall 22. In the example shown in the illustration there is some additional material that has been laid down. However this is still within acceptable limits.

Thus when the full layer of fibrecrete 45 has been applied to the wall 42 as shown in FIG. 11, it is only the cap 30 that projects out above the fibrecrete. The rest of the indicator is embedded within the fibrecrete. The cap 30 has a greater cross-section area than the shank 5 and this presents a large object that can easily be seen by people in the passage. During subsequent blasting operations in the passage the cap 30 will be exposed to extreme forces and this may result in the cap body 32 being blown off. However if this occurs the disc 34 will remain behind. This is because the base end part 18 of the shank passes fully through the disc 34 and because it is at least partially surrounded by fibrecrete. The disc 34 has the same cross-section area as the cap body 32 and this will also present a large object that is clearly visible to people standing on the floor of the tunnel.

The caps 30 may be colour coded in the same way as the shank 5 and shank extension 21 described above with reference to FIGS. 1 to 3. For example a cap 30 of one colour, e.g. red is used if the marker indicates a fibrecrete depth of 50 mm. The cap 30 may be another colour, e.g. yellow if the marker indicates a fibrecrete depth of 75 mm. The cap may yet be another colour, e.g. green if the marker indicates a fibrecrete depth of 100 mm.

That way engineers can enter the tunnel at any time, even several years after the screening has taken place, and see immediately what the depth of the fibrecrete is based on the colour of the caps or discs on the roof and walls.

A similar procedure of applying further indicators 1 to the wall 42 and then measuring the depth of the fibrecrete off these indicators 1 is used at spaced intervals across the wall 42. This way a contractor can be sure that they have screened to the correct depth and no more. Generally a section of the tunnel having a length of about 4 m is covered with fibrecrete in each operation. The tunnel might have a width of 5-6 m and a height of 4-6m.

An example layout of depth indicators 1 on a wall 22 is shown in FIG. 12. In this example the indicators 1 are arranged in the form of a two dimensional array or matrix and the individual indicators 1 are arranged 5 m apart from each other in two dimensions.

Of course these dimensions could vary. For example the adjacent indicators 1 may be 2 m apart from each other. Generally this will be left up to operators' discretion. Alternatively a customer such as a mine may specify a certain layout of indicators in the contract. Further a standard arrangement and lay out of these markers across wall may be developed over time.

When the mine operator inspects the work after it is complete they will readily be able to see that a screen of 50 mm has been applied to the walls. It will not be necessary to drill into the fibrecrete to check on its thickness.

If a mine operator requires a screen depth of greater than 50 mm, say 75 mm, then a shank extension 21 is mounted on the shank 5 of each indicator in the manner shown in FIGS. 1 and 3 and then the fibrecrete is laid onto the wall 42 in the manner described above.

The operator will know that they have laid down a 75 mm layer of fibrecrete when the layer extends to the tip or free end of the shank extension 21.

Further shank extensions 21 could be used in a similar way to build an indicator 1 capable of indicating an even greater depth than 75 mm. For example a further shank extension 21 of 25 mm would yield an indicator capable of indicating a depth of 100 mm. Of course the first shank extension 21 could also be removed and replaced with a single shank extension of 50 mm to achieve the same result.

FIGS. 13 and 14 are sectional views of a depth indicator in accordance with a further embodiment of the invention.

The depth indicator 1 is similar to that described above with reference to FIGS. 1 to 9. Accordingly unless otherwise indicated the same reference numerals will be used to refer to the same components.

The main difference between this embodiment and the FIG. 1 embodiment is that this embodiment includes means for indicating the time that has elapsed since the indicator was mounted on the wall 42 and therefore also the time that has elapsed since the layer 45 of fibrecrete was sprayed onto the wall. The following description therefore will focus on this feature.

In FIG. 13 the shank of the indicator 1 includes a visual elapsed time indicating means that includes two containers 50, 52, one received within the other. Each container 50, 52 contains a material that when mixed with the material in the other container initiates glowing of the mixed materials. The inner container 50 is made of a material that is quite brittle and is susceptible to cracking when a moment is applied thereto. By contrast the outer container 52 is more flexible and can bend when a moment is applied thereto without cracking or breaking.

As a result when a user bends the shank of the indicator 1, the inner container 50 cracks open allowing its contents to mix with the contents of the outer container 52. The contents of the first and second compartments can mix with each other but cannot escape from the confines of the outer container 52. The contents of the containers 50, 52 contain fluorescent material that when mixed together glow and emit fluorescent light. The glowing of the indicator 1 is very similar to the glowing of well known glow sticks that are available in shops and used at children's parties and the like.

The amount of material that is contained within the containers is carefully metered so as to glow for said predetermined period of time, eg be it one or two hours, and then cease glowing at the end of this time period. This therefore serves as a visual indication that the predetermined time has elapsed since it was cracked. This indication of elapsed time is available for all personnel to see within the rock passage. This is a signal that they can re-enter the tunnel.

In the use of this embodiment the shank 5 of the indicator 1 is cracked open to cause the materials within the two compartments 50, 52 to mix with each other and commence glowing as shown in FIG. 14. The bending of the shank 5 to crack the container 50 is done just prior to the indicator 1 being mounted on the end of a nozzle 40 of a spraying apparatus. The nozzle 40 is then used to lift the indicator 1 up and press it into position on the rock wall 40. The indicator 1 is held on the rock wall 42 by means of adhesive as described above for the embodiment described with reference to FIGS. 1 to 11.

Thus when the indicator 1 is placed up on the rock wall 42 it glows and emits a bright fluorescent light. This bright light may be red or green or indeed several other colours. FIG. 15 shows the indicator 1 emitting light mounted on the rock surface 42 with the full layer 45 of fibrecrete on the rock surface 42.

As described above the fluorescent material is designed to cease glowing once the predetermined time period has elapsed. Accordingly after one or two hours as the case may be the shank 5 of the indicator 1 stops glowing and this serves as a sign to workers in the area that it is now safe to re-enter the mine passage in this area. Mine managers are particular anxious to ensure that mine workers be given access to an area that has been screened with fibrecrete as soon as possible after the fibrecrete has been laid down. The elapsed time indicating means would enable this to be signalled to workers clearly and efficiently.

Generally the predetermined time is that at which the fibrecrete will have attained sufficient early strength to permit people to re-enter the section. Generally the fibrecrete will have sufficient early strength after about 30 mins to 1 hour. Applying a safety factor of 2 the predetermined time will be 1 to 2 hours.

FIG. 16 illustrates an indicator that is a variation on that shown on FIGS. 13 to 15.

The main difference between this embodiment and the earlier one is that the light emitted by the indicator is emitted by one or more LED's 55. The LED's 55 are mounted on the free end portion 18 of the shank 5 such that they are still exposed once the layer of fibrecrete has been laid down to its full depth.

Further the free end portion 18 of the shank 5 may be covered by a cap 30 that acts as a lens and is transparent.

The indicator 1 may further include a time measuring means, e.g. in the form of a chip or processor 56 that is operatively coupled to the LED 55. The LED 55 and processor 56 is energised by a battery 57. The chip or processor 56 measures the elapsed time after it is activated when the indicator has been mounted on the support surface. It causes said LED 55 to stop glowing once the predetermined time has elapsed.

One benefit of this embodiment is that the elapsed time or predetermined time can be very accurately measured and the LED 55 can be de-activated at precisely this time.

FIG. 17 illustrates an indicator in accordance with another embodiment of the invention.

In this embodiment the depth indicator 1 and more particularly the shank 5 thereof has a supporting formation 62 including a loop or hook mounted thereto.

The shank has an attachment formation 60 towards its free end on which the supporting formation 62 is mounted. In the illustrated embodiment the attachment formation 60 may be a screw thread formation on the external surface of the shank 5 towards the free end thereof.

The supporting formation 62 has a bore defining a complementary screw thread formation 64 that can then be screwed onto the screw thread formation 60 on the shank 5.

The FIG. 17 shows a number of different loops, hooks and eyes that can be attached to the support formation 62. The loops, hooks and eyes in turn are attached to the formation 62 by means of screw threaded engagement. The loops, hooks and eyes have external screw threads that are received within bores defined in the formation 62 having complementary internal screw threads.

By having indicators 1 having this feature located at spaced intervals along the length of the passage cables 66 can be hung from these indicators 1. As described above with reference to FIGS. 1 to 10 the indicators 1 are very securely mounted on the support surface by the fibrecrete.

FIG. 18 shows an indicator 1 with a support formation 60 mounted thereto.

The support formation 62 includes a pair of hook formations 68 below the fibrecrete surface which are used for carrying cables and pipes 66. Typically these might be cables 66 providing services. The hook formations 68 have screw threads that are screwed into bores in the formation 60 in the manner shown in the drawings.

FIG. 19 shows an indicator 1 with another support formation 60 mounted thereto.

This support formation comprises two rings or eyes 69 within which the cables 66 are received.

An advantage of the depth indicator as described above with reference to the drawings is that it provides a relatively easy and trouble free way of checking the depth of a layer of fibrecrete. Further it indicates the depth of the layer to an operator as it is being laid down and does not require an operator to interrupt the spraying of the material to check the depth. They get a visual indication of the depth of the material while they are still spraying the material onto the surface and do not need to down their tools to determine the thickness of the material. It thus provides a way of noting the depth of the material in real time, i.e. as the layer is being laid down.

A further advantage of the depth indicator is that it has potentially a very wide application. It can be applied to all applications where a non transparent settable material is applied to a surface to provide a reliable indication of the depth of the material.

A further advantage is that the indicators remain in place and are visible and can be inspected several years later. Further the colour coding enables the depth of the layer to be gleaned from the colour of the indicator that is used.

A further advantage of the invention is that the indicator itself is relatively simple and can be produced relatively inexpensively. Further it is easy to use and apply and can be used by operators without any training. Yet further it can be adapted to accommodate layers of different thickness.

A yet further advantage is that it can be applied using the same nozzle that is used to spray concrete slurry. The nozzle can be used to reach up and place the nozzle on the rock face.

An advantage of one embodiment described above with the light or glow it provides a reliable indicator of when sufficient time has elapsed by workers, and also clearly indicates for it to become safe to re-enter the area. Further it does this in a way which is immediately obvious to any person working in the area. A yet further advantage of this embodiment is that it is relatively simple to construct and use.

It will of course be realised that the above has been given only by way of illustrative example of the invention and that all such modifications and variations thereto as would be apparent to persons skilled in the art are deemed to fall within the broad scope and ambit of the invention as is herein set forth.

1. An indicator for indicating the depth of a layer of a settable material that has been applied to a support surface, the indicator comprising: a base defining a contact surface for mounting on a support surface; and a shank having one end mounted on said base and projecting transverse away from the base to a free end remote from said base.

2. An indicator for indicating the depth of a layer of a settable material according to claim 1, wherein the base and the shank together have a length or height that is at least that of the thickness of the settable material that is to be laid on the support surface.

3. An indicator for indicating the depth of a layer of a settable material according to claim 1, including at least one indicating marker on the shank for indicating the depth of settable material on the support surface when it is filled up to the level of the marker.

4. An indicator for indicating the depth of a layer of a settable material according to claim 3, wherein the indicating marker on the shank indicates a depth of 50 mm, 75 mm or 100 mm.

5. An indicator for indicating the depth of a layer of a settable material according to claim 1, wherein the depth of the settable material on the support surface is obtained by subtracting the exposed length of the shank from the sum of the height of the base and the length of the shank.

6. An indicator for indicating the depth of a layer of a settable material according to claim 1, wherein the base is flattened and has said contact surface for mounting on the support surface and also an opposed or outward surface for facing away from the support surface on which the indicator is mounted.

7. An indicator for indicating the depth of a layer of a settable material according to claim 6, wherein the base is sized to have a diameter larger than that of a nozzle that is typically used to spray concrete slurry, such that the indicator can be mounted over the open end of an upwardly facing nozzle and be supported by the nozzle whereby to place the indicator on the support surface.

8. An indicator for indicating the depth of a layer of a settable material according to claim 7, wherein the base includes a locating formation on said outward surface for correctly locating the base in position on said nozzle when it is mounted over the open end of the nozzle.

9. An indicator for indicating the depth of a layer of a settable material according to claim 8, wherein the locating formation is in the form of a shoulder of substantially circular shape spaced radially in from the peripheral edge of the base and the shoulder is sized to fit inside the typical nozzle with a small amount of clearance.

10. An indicator for indicating the depth of a layer of a settable material according to claim 6, wherein the contact surface of the base defines a recess slightly inward of the peripheral edge to permit adhesive to remain between the contact surface and the support surface when the base is pressed against the support surface.

11. An indicator for indicating the depth of a layer of a settable material according to claim 10, wherein the base further defines one or more apertures passing there through from the contact surface to the outward surface, the apertures permitting adhesive that is applied to the contact surface to pass from the contact surface through to the outward surface when the base is pressed against the support surface.

12. An indicator for indicating the depth of a layer of a settable material according to claim 11, wherein there are there are 5 to 7 apertures and the diameter of each aperture is 2-6 mm.

13. An indicator for indicating the depth of a layer of a settable material according to claim 3, wherein the shank has a main shank portion and a free end portion of smaller cross-sectional area than the main shank portion on the end of the main shank portion.

14. An indicator for indicating the depth of a layer of a settable material according to claim 13, wherein the main shank portion has a noncircular cross-sectional configuration.

15. An indicator for indicating the depth of a layer of a settable material according to claim 14, wherein the main shank portion has a cross sectional configuration in the shape of a figure having a plurality of linear sides such as a cross or a cruciform, the sides of the shank providing a surface against which the settable material can bear when it is sprayed out of the nozzle to guide the settable material along the shank and up against the outer surface of the base.

16. An indicator for indicating the depth of a, layer of a settable material according to claim 13, wherein the indicating marker of the depth of the settable material comprises the end of the main shank portion which is positioned to correspond to the desired thickness of the layer of settable material.

17. An indicator for indicating the depth of a layer of a settable material according to claim 13, wherein the free end portion is of a substantially smaller cross-sectional area than the main shank portion and the free end portion forms an attachment formation for mounting other components on the shank of the indicator.

18. An indicator for indicating the depth of a layer of a settable material according to claim 17, further including a cap removably mounted on the shank.

19. An indicator for indicating the depth of a layer of a settable material according to claim 18, wherein the cap is mounted on the free end portion of the shank.

20. An indicator for indicating the depth of a layer of a settable material according to claim 19, wherein the cap includes a main body portion and a disc separate from the main body portion, and the disc is sandwiched between the main body portion of the cap and the main shank portion of the shank.

21. An indicator for indicating the depth of a layer of a settable material according to claim 20, wherein the main body portion and the disc each define a passageway, within which the free end portion of the shank is received to hold the cap on the shank.

22. An indicator for indicating the depth of a layer of a settable material according to claim 21, wherein the main body portion has a conical part towards its free end and a cylindrical part behind the conical part and remote from its free end and said disc sits behind the cylindrical part.

23. An indicator for indicating the depth of a layer of a settable material according to claim 13, further including a shank extension that can be mounted on the free end portion of the shank to give the indicator additional length in the direction of the shank, and wherein said shank extension defines a passage within which the free end portion of the shank is received to releasably mount the shank extension on the shank.

24. An indicator for indicating the depth of a layer of a settable material according to claim 23, including a yet further shank extension mounted on said shank extension to give the indicator even more length in the direction of the shank, and wherein said further shank extension defines a passage within which a leading portion of the first shank extension is received to releasably mount the further shank extension on the first shank extension.

25. An indicator for indicating the depth of a layer of a settable material according to claim 1, wherein the base and shank are integrally moulded from a plastics material in an injection moulding operation.

26. An indicator for indicating the depth of a layer of a settable material according to claim 1, wherein the indicator includes means for visually indicating when a predetermined time has elapsed mounted on the shank.

27. An indicator for indicating the depth of a layer of a settable material according to claim 26, wherein the predetermined time that is measured by the elapsed time indicating means is a time of from one hour to three hours.

28. An indicator for indicating the depth of a layer of a settable material according to claim 26, wherein the visual indicating means also indicates when the elapsed time indicating means has been activated so as to start measuring the predetermined time as well as indicating when the predetermined time has elapsed.

29. An indicator for indicating the depth of a layer of a settable material according to claim 28, wherein the visual indicating means illuminates or glows when activated and then stops glowing or illuminating once the predetermined time has elapsed.

30. An indicator for indicating the depth of a layer of a settable material according to claim 29, wherein the means for visually indicating that the predetermined time has elapsed comprises a brittle inner container that can be cracked open by bending the container and an outer container that is less brittle, within which the inner container is received, the two containers containing different liquids that mix when the inner container is cracked open and catalyse a reaction between the two liquids that causes them to glow.

31. An indicator for indicating the depth of a layer of a settable material according to claim 26, wherein the means for visually indicating that the predetermined time has elapsed comprises an electronic time measuring means operatively coupled to a light comprising one or more LED's mounted towards the free end of the shank that illuminates in response to the electronic time measuring means.

32. An indicator for indicating the depth of a layer of a settable material according to claim 1, further including a support formation that is suitable for supporting one or more articles there from that is mounted on the shank towards the free end thereof.

33. An indicator for indicating the depth of a layer of a settable material according to claim 32, wherein the support formation is in the form of a loop or a hook formation for supporting cables and conduits there from.

34. An indicator according to claim 33, wherein the support formation is either integral with the shank of the indicator or is attached thereto.

35. An indicator for indicating the depth of a layer of a settable material according to claim 34, wherein the support formation is attached to the indicator, and the indicator includes attachment means on the shank towards the free end of the shank, and the support formation includes complementary attachment formations for engaging the attachment formations on the shank thereby to attach the support formation to the shank.

36. An indicator for indicating the depth of a layer of a settable material according to claim 35, wherein the attachment means on the shank comprises an external screw thread towards the free end thereof and the complementary attachment means on the hanging formation comprises a bore defining an internal screw thread within which the screw thread on the shank is received.

37. A support for mounting to a support surface, the support comprising: a base defining a contact surface for mounting on a support surface; a shank having one end mounted on said base and projecting transverse away from the base to a free end remote from said base; and a formation that is suitable for supporting articles there from or attaching articles there to that is mounted on the shank towards the free end thereof.

38. A support according to claim 37, wherein the base and the shank have a length that is at least that of the settable material that is to be laid on the support surface.

39. A support according to claim 38, wherein the formation is a support formation including a hook or a loop that is suitable for hanging articles such as cables, pipes or the like, there from.

40. A method of applying a layer of settable material onto a support surface, the method comprising the steps of: providing at least one depth indicator as described above according to the first aspect of the invention; placing the indicator on the support surface and adhering it thereto; and applying the settable material to the support surface; whereby to indicate the depth of the material on the support surface by the length of the shank of the indicator that still remains exposed and is not covered by the settable material.

41. A method according to claim 40, wherein the indicator is in accordance with claim 1.

42. A method according to claim 41, wherein the step of measuring the depth of the material comprises taking the length of the shank and height of the base and subtracting from it the exposed length of shank to arrive at the depth of material that has been put down on the support surface.

43. A method according to claim 40, wherein the indicator includes an indicating marker on the shank for indicating the depth of the settable material and the step of applying the settable material includes applying the material at least up to the level of the indicating marker.

44. A method according to claim 43, wherein the settable material is a cementitious material which is in the form of concrete, cement or fibrecrete and the material is in the form of a slurry that is pumped or sprayed onto the support surface with a nozzle.

45. A method according to claim 44, wherein the support surface is a rock surface of a rock wall in an underground passage or tunnel and the material that is placed on the wall is fibrecrete.

46. A method according to claim 40, further including the initial step of placing the indicator over the end of a nozzle of a slurry pumping apparatus prior to the step of placing it on the support surface.

47. A method according to claim 46, also including the further initial step of placing adhesive on the contact surface of the base of the indicator, the adhesive being placed on the base while it is being supported on the end of the nozzle.

48. A method according to claim 47, wherein the step of placing and adhering the indicator on the support surface includes pressing the indicator onto the support surface with sufficient pressure for the adhesive to be brought firmly into contact with the support surface and be forced through the apertures in the base member.

49. A method according to claim 40, including placing a plurality of said indicators in position on the support surface at spaced apart positions on the support surface prior to pumping said slurry of settable material onto the wall.

50. A method according to claim 49, wherein the plurality of indicators are positioned in a pattern, eg an array, on the support surface.

51. A method according to claim 40, including the further step of providing a visual indicator of elapsed time on at least one depth indicator.
